(19) United States
(12) Patent Application Publication
(10) Pub. No.: US 2010/0015396 A1
(43) Pub. Date: Jan. 21, 2010

(54) BARRIER COATINGS, METHODS OF MANUFACTURE THEREOF AND ARTICLES COMPRISING THE SAME

(75) Inventors: Curtis Alan Johnson, Niskayuna, NY (US); Reza Sarrafi-Nour, Clifton Park, NY (US); Daniel Gene Dunn, Guilderland, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/176,508

(22) Filed: Jul. 21, 2008

(51) Int. Cl. B32B 5/16; B05D 1/08; B32B 5/02; B32B 18/00

(52) U.S. Cl. 428/142; 428/338; 427/446; 428/293.4

(57) ABSTRACT

Disclosed herein is an article comprising a substrate; the substrate comprising a ceramic or a ceramic matrix composite; and a layer comprising coarse particles disposed upon the substrate; the coarse particles having an average particle size of 0.1 to about 1000 micrometers. Disclosed herein too is a method comprising disposing coarse particles on a substrate; the substrate comprising a ceramic or a ceramic matrix composite; the coarse particles having an average particle size of 0.1 to about 1000 micrometers.

### BACKGROUND

This disclosure relates to barrier coatings, methods of manufacture thereof, and articles comprising the same.

Environmental barrier coatings (EBC's) are applied to articles, such as high temperature machine components, where the articles comprise materials susceptible to attack by high temperature water vapor, thus providing environmental protection by prohibiting contact between the water vapor and the surface of the article. EBC's are designed to be relatively chemically stable at high-temperatures, and water vapor-containing environments. They are also designed to minimize porosity and prevent the formation of vertical cracks that provide exposure paths between the article surface and the environment. EBC's are often applied by plasma spray and thermal spray processes.

To enhance EBC adhesion, many deposition processes, such as thermal spray deposition, include roughening the surface of an article prior to application of the EBC. The roughening is accomplished by a grit blast process performed prior to application of the EBC. Grit materials comprise alumina, silicon carbide, diamond, or others.

Articles for high temperature machines, such as gas turbines, can have a highly engineered structure to accommodate the mechanical stresses encountered during use. For example, current commercial articles can include a matrix layer disposed on an underlying fiber reinforced architecture to protect the underlying architecture from damage. Grit blasting, if not performed in a controlled manner, can erode the matrix and damage the underlying fiber reinforced architecture. In addition, for some gas turbine components, particularly airfoil shapes such as the blades, vanes and nozzles of a gas turbine engine, the surface profile and/or surface flatness can dictate the performance of the article and the efficiency of the engine. Thus imperfections in the surface of the article can result in reduced performance, including engine performance and engine efficiency. Thus the grit blast process is commercially performed in a controlled manner to avoid issues such as mechanical damage to the underlying architecture of the article or alteration of the shape or surface profile of the article. This causes an increase in production time and consequently in manufacturing costs.

Accordingly, there remains a need for improved methods to roughen the surface of articles to enhance EBC adhesion. In particular, there remains a need for processes that reduce the likelihood of damage to the underlying article in a surface modification process. In addition there remains a need for processes that reduce the cost of the manufacturing process processes.

### SUMMARY

Disclosed herein is an article comprising a substrate; the substrate comprising a ceramic or a ceramic matrix composite; and a layer comprising coarse particles disposed upon the substrate; the coarse particles having an average particle size of 0.1 to about 1000 micrometers.

Disclosed herein too is a method comprising disposing coarse particles on a substrate; the substrate comprising a ceramic or a ceramic matrix composite; the coarse particles having an average particle size of 0.1 to about 1000 micrometers.

These and other features, aspects, and advantages of the disclosed embodiments will become better understood with reference to the following description and appended claims.

### BRIEF DESCRIPTION OF THE DRAWINGS

The disclosed subject matter is particularly pointed out and distinctly claimed in the claims at the conclusion of the specification. The foregoing and other objects, features, and advantages of the disclosed embodiments are apparent from the following detailed description taken in conjunction with the accompanying drawings in which:

FIG. 1 is an exemplary depiction of one method of manufacturing the roughened surface;

FIG. 2 is an exemplary depiction of another method of manufacturing the roughened surface;

FIG. 3 is an exemplary depiction of another method of manufacturing the roughened surface;

FIG. 4 is an exemplary depiction of yet another method of manufacturing the roughened surface;

FIG. 5 is a photograph of the roughened surface of the sample from Example 1 that contains coarse silicon carbide particles;

FIG. 6A is a photograph depicting the mode of failure of Comparative Example 1 (Coupon 1);

FIG. 6B is a photograph depicting the mode of failure of Example 1 (Coupon 2);

FIG. 7 is a bar graph that compares pull adhesion strengths for the representative samples (Coupon #s 3 and 4) with the Comparative Examples (Coupon #s 5 and 6).

The detailed description explains the preferred embodiments, together with advantages and features, by way of example with reference to the drawings.

### DETAILED DESCRIPTION

The singular forms “a,” “an,” and “the” include plural referents unless the context clearly dictates otherwise. Unless defined otherwise, technical and scientific terms used herein have the same meaning as is commonly understood by one of skill in the art to which this invention belongs.

The modifier “about” used in connection with a quantity is inclusive of the stated value and has the meaning dictated by the context (e.g., includes the degree of error associated with measurement of the particular quantity). The notation “±10%” means that the indicated measurement can be from an amount that is minus 10% to an amount that is plus 10% of the stated value.

The endpoints of all ranges directed to the same component or property are inclusive and independently combinable (e.g., ranges of “less than or equal to about 25 wt %, or, more specifically, about 5 wt % to about 20 wt %,” is inclusive of the endpoints and all intermediate values of the ranges of “about 5 wt % to about 25 wt %,” etc.).

The suffix “(s)” as used herein is intended to include both the singular and the plural of the term that it modifies, thereby including at least one of that term (e.g., the colorant(s) includes at least one colorant). “Optional” or “optionally” means that the subsequently described event or circumstance can or cannot occur, and that the description includes instances where the event occurs and instances where it does not. All cited patents, patent applications, and other references are incorporated herein by reference in their entirety.

Disclosed herein is a method of producing a rough surface that comprises disposing coarse particles on the surface of the substrate to form a coated substrate and subjecting the coated substrate to a thermal process to facilitate bonding between the particles and the substrate. In one embodiment, a layer comprising coarse particles may be disposed upon the substrate. In one embodiment, the coarse particles can withstand continuous operating temperatures of greater than or equal to about 1500° C. In an exemplary embodiment, the coarse particles are similar in composition to the matrix of the substrate and are therefore thermally, mechanically, and chemically compatible with the matrix. The coarse particles may be bonded to the surface of the substrate or maybe partially embedded in the substrate or may be bonded to or partially embedded in a surface layer that is compatible with the substrate.

An example of a surface layer that is compatible with the substrate is a silicon layer on a silicon-silicon carbide substrate. The coarse particles at the surface of the substrate provide a rough exposed surface that can be used to bond or mechanically interlock the substrate to an environmental barrier coating (EBC).

Disclosed herein too are articles manufactured using the aforementioned method. The substrate with the EBC layer disposed thereon can advantageously be used in devices such as turbines (e.g., gas turbines, steam turbines), motors, and the like.

The article and the processes described herein have a number of advantages. Because the disclosed process does not involve erosion of the surface of the substrate, as would occur in grit blasting, damage to the substrate is avoided. In addition, the profile of the article does not change in an undesirable manner as it does when grit blasted. Also, by avoiding spraying with abrasive grit, the disclosed process avoids the cost and complexity of the grit blasting process.

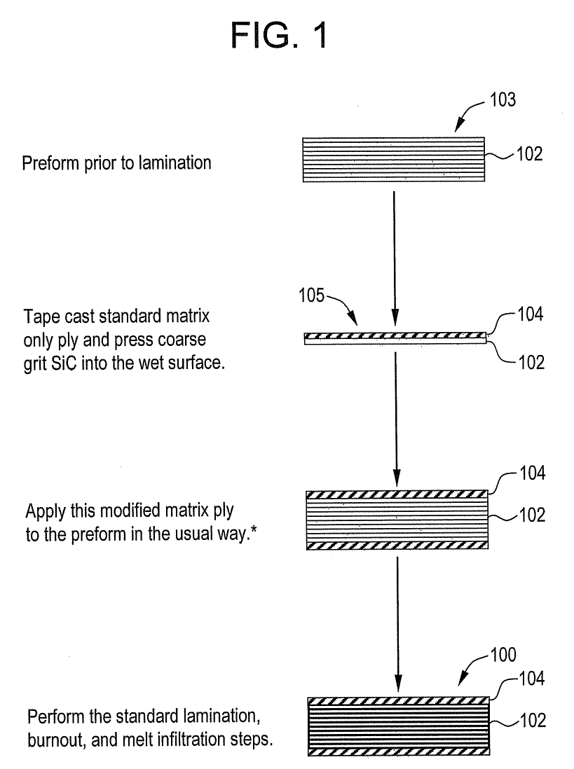

With reference now to the FIGS. 1 through 4, the rough surface can be produced by a number of different methods. The FIGS. 1 through 4 depicts a substrate that comprises a laminate. The laminate comprises a plurality of slurry-impregnated plies. In one embodiment, the individual plies that form the laminate can comprise a fibrous reinforcing phase. In another embodiment, the individual plies that form the laminate do not comprise a fibrous reinforcing phase. When the ply comprises a fibrous reinforcing phase, the reinforcing phase can comprise a woven or non-woven network of silicon carbide fibers or carbon fibers. The fibers may have a coating disposed thereon as detailed in U.S. Pat. No. 6,258,737 to Steibel et al., the entire contents of which are hereby incorporated by reference.

The substrate can comprise a ceramic or a ceramic matrix composite (CMC). While the FIGS. 1 through 4 depicts a substrate that comprises a laminate, it is not always desirable to use a laminate. Thus the substrate can also comprise a monolithic ceramic that comprises silicon carbide or silicon nitride. The substrate can also be a CMC formed from reinforcing fiber that is braided or weaved.

In the FIGS. 1 through 4, the substrate is a laminated preform 103 that comprises a plurality of plies 102. As can be seen in the FIG. 1, a matrix-only ply 102 is tape cast and the coarse particles are pressed into the wet tape 104 (of the tape cast) to form a coarse particle ply 105. The matrix-only ply is one having the same composition as the laminated preform 103. This coarse particle ply 105 is then disposed on the outside of the laminated preform 103 prior to lamination. As will be described later, it is also possible to dispose the wet tape 104 on to a laminated preform 103, dispose coarse particles on the wet tape 104 and perform a subsequent lamination to promote adhesion. The preform 102 with the coarse particle ply 105 (or the wet tape 104 having the coarse particles disposed thereon) is then subjected to burnout and melt infiltration steps that will be detailed later. In an exemplary embodiment, the laminated preform comprises silicon carbide fibers impregnated with a matrix precursor as described in U.S. Pat. No. 6,258,737. The matrix precursor is described later in this disclosure.

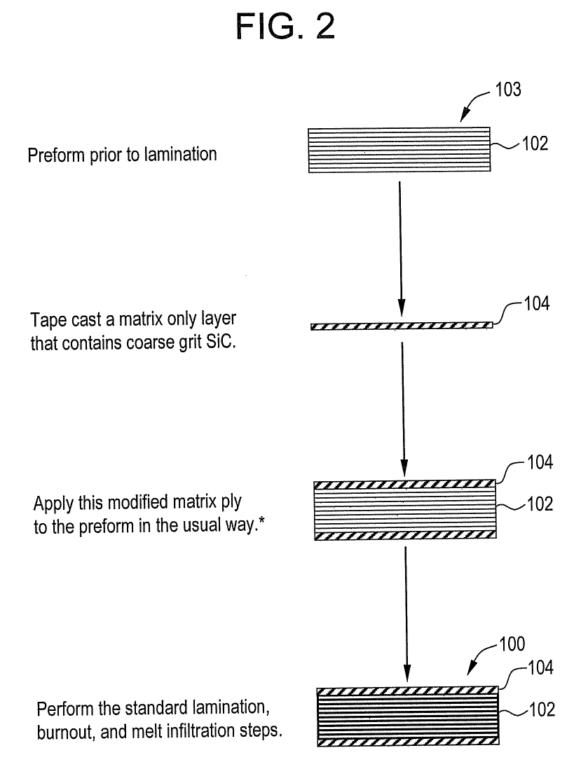

In the FIG. 2, the coarse particle ply 105 is fabricated by incorporating the coarse particles in the matrix precursor slip and then tape casting the coarse particle ply 105 to a non-fiber containing ply. This coarse particle ply 105 is then adhered to the laminate as described above. The laminated preform 103 with the coarse particle ply 105 is then subjected to burnout and melt infiltration steps.

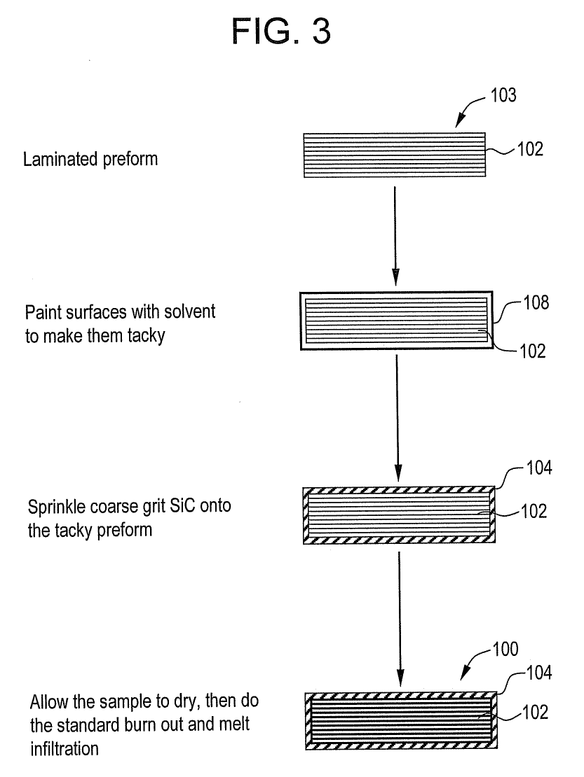

In the FIG. 3, the surface 108 of the laminated preform 103 is softened by treating it with a suitable solvent. The coarse particles are then embedded into this treated surface 108 while it is still tacky in order to form the layer 104. Pressure may be applied to press the coarse particles into the laminated preform 103. The laminated preform 103 with the layer 104 comprising coarse particles is then subjected to burnout and melt infiltration steps. The solvent used in the slurry or used to paint the surfaces directly (as depicted in the FIG. 3) should dissolve or partially dissolve the resins in the matrix precursor. The coarse particles are then partially embedded in the soft surface matrix and held in place through mechanical interlocking.

The surface treatment described in the FIG. 3 can also be used to adhere the coarse particle ply 105, described in FIGS. 1 and 2, to a laminated preform. A second lamination step is performed to promote adhesion.

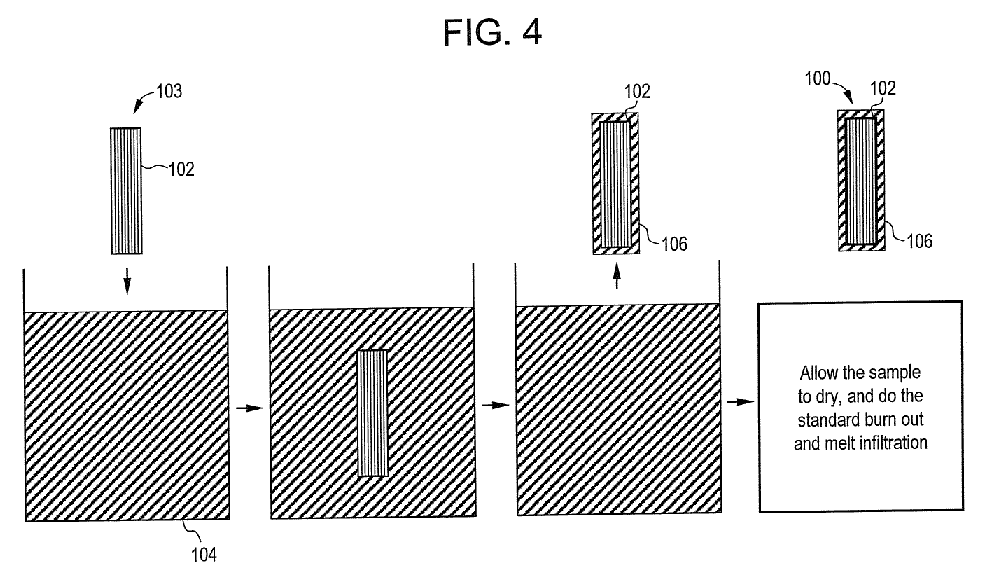

In FIG. 4, the laminated preform 103 is immersed into a slurry 106 that comprises the coarse particles. Alternatively, the slurry can be disposed onto the laminated preform 103 using brush painting, spray painting, electrostatic spray painting, or the like. The slurry 106 is disposed on the laminated preform 103. The laminated preform 103 with the slurry 106 comprising coarse particles disposed thereon is then subjected to burnout and melt infiltration steps. The slurry 106 of the FIG. 4 comprises a suspension of the coarse particles and is further described below.

Thus, from the FIGS. 1 through 4, the laminated preform 103 can either have the coarse particle ply 105 adhered to its surface or it can have the coarse particles sprinkled on its surface after the surface has been treated with a suitable solvent. The laminated preform 104 can also be coated with the slurry 106 by a variety of painting and immersion processes as depicted in the FIG. 4.

The slurry 106 comprises a matrix precursor and the coarse particles. The matrix precursor generally comprises high char yielding resins, particles of carbon and/or silicon carbide, and a solvent. The matrix precursor is generally used to coat the silicon carbide or carbon fibers prior to burn-out and infiltration to form the substrate. Coarse particles comprising silicon carbide are added to the matrix precursor to form the slurry. The substrate is immersed into the slurry as depicted in the FIG. 4 and detailed above.

In one embodiment, the matrix precursor generally comprises high char yielding resins for impregnating fiber tows in one-dimensional and two-dimensional structures, or two and three-dimensional structures using resin transfer molding. The addition of high char yielding resins to the matrix precursor increases burnout strength and produces a hard, stable substrate. The term “high char yielding resin” means that after burnout, the resin decomposes and leaves behind solid material, such as carbon, silicon carbide, and silicon nitride. The high char yielding resin provides integrity to the preform structure during burnout and subsequent silicon melt infiltration steps. The high char yield resin also improves the handling ability and machinability of the substrate.

Examples of high char yielding resins that are suitable for use in the slurry are carbon forming resins and ceramic forming resins. Carbon forming resins can comprise phenolics, furfuryl alcohol, partially-polymerized resins derived therefrom, petroleum pitch, and coal tar pitch. Ceramic forming resins comprise those resins which upon pyrolyzation form a solid phase (crystalline or amorphous) that include one or more of the following: silicon carbide, carbon, silicon nitride, silicon-oxycarbides, silicon-carbonitrides, boron carbide, boron nitride, and metal carbides or nitrides where the metal is generally zirconium, titanium, or a combination comprising at least one of the foregoing metals. Further examples are polycarbosilanes, polysilanes, polysilazanes, and polysiloxanes.

The matrix precursor generally comprises particles of carbon, silicon carbide or combinations of carbon and silicon carbide. Small carbon particles and small silicon carbide particles, as present in the matrix precursor (either alone or as an admixture), allow penetration or impregnation into the tows of the small diameter fibers during prepreg formation or resin transfer molding. The small carbon particles and small silicon carbide particles generally have an average particle size of about 0.1 to about 20 micrometers. In one embodiment, the small carbon particles and small silicon carbide particles generally have an average particle size of about 0.2 to about 5 micrometers. In another embodiment, the small carbon particles and small silicon carbide particles generally have an average particle size of about 0.3 to about 3 micrometers. In yet another embodiment, the small silicon carbide particle has a mean particle size of less than or equal to about one micrometer.

Appropriate solvents can be used in the matrix precursor. In one embodiment, it is desirable for the solvent to partially or fully dissolve the organic components of the slurry. Examples of solvents that can be used in the slurry include water-based solvents, water, organic-based solvents, toluene, xylene, methyl-ethyl ketone, methyl-isobutyl ketone (4-methyl-2-pentanone), acetone, alcohols such as ethanol, methanol, isopropanol, n-butyl alcohol, 1,1,1-trichloroethane, tetrahydrofuran, tetrahydrofurfuryl alcohol, FSX-3 (a product distributed by Bargamo Corporation, Westport, Conn.), cellosolve, butyl cellosolve, glacial acetic acid, acetone, butyl acetate, N-butyl alcohol, cyclohexane, diacetone alcohol, N,N-dimethylacetamide, N,N-dimethylformamide, dimethyl ester, dimethylsulfoxide, ethyl acetate, ethylene dichloride, isophorone, isopropyl acetate, methyl acetate, methylene chloride, N-methyl-2-pyrrolidone, propylene dichloride, SANTOSOAL® DME-1, tetrahydrofuran, toluene, 1,1,1-trichloroethane, xylene, or the like, or a combination comprising at least one of the foregoing solvents.

In manufacturing the substrate, the bundles of fibers are formed into complex shapes and structures that act as the substrate for purposes of this disclosure. In one embodiment, the bundles of fibers are impregnated with the matrix precursor to form a desired shape or structure called a preform. In another embodiment, the fibers are placed in a mold and are impregnated with the matrix precursor to form a desired shape or structure called a preform. Once the bundles of fibers are impregnated with the matrix precursor, and shaped to the desired structure, it is subjected to a burn-out. The burn-out yields a high char residue. It is desirable to have a high char residue prior to molten silicon infiltration, so as to provide dimensional stability of the preform and to provide carbon for the subsequent reaction with the molten silicon to form the silicon-silicon carbide composite substrate.

In addition to the char yielding resins, the carbonaceous material in the substrate may be added as elemental carbon including graphite particles, flakes, whiskers, or fibers of amorphous, single crystal, or polycrystalline carbon, carbonized plant fibers, lamp black, finely divided coal, charcoal, and carbonized polymer fibers or felt such as rayon, poly-acrylonitrile, and polyacetylene.

The carbon used in the substrate can be in the form of a powder and may have an average particle size of less than or equal to about 50 micrometers. In one embodiment, the carbon used in the substrate can be less than or equal to about 10 micrometers.

After the substrate is laminated and pyrolized, it is infiltrated by molten silicon as discussed above. In carrying out the present process, the substrate is contacted with the molten silicon infiltrant. The molten silicon infiltrates the substrate. U.S. Pat. No. 4,737,328 to Morelock, incorporated herein in its entirety by reference, discloses an infiltration technique. In addition, U.S. Pat. No. 6,403,158 to Corman, the entire contents of which are hereby incorporated by reference, discloses another infiltration technique.

The substrate thus obtained is then coated with the coarse particles as shown in the FIGS. 1 through 4. It is to be noted that while the coarse particles can be disposed on the substrate prior to lamination as disclosed in the FIGS. 1 through 4, they can be also disposed on the substrate prior to the burnout or prior to the melt infiltration step. As shown in the FIG. 4, one manner of disposing the coarse particles on the substrate is by immersing the substrate in a slurry 106. The slurry 106 is obtained by mixing the matrix precursor with additional coarse particles. The coarse particles used in the slurry are capable of withstanding elevated temperatures that the substrate is subjected to during the course of usage. In one embodiment, it is desirable for the coarse particles to have a melting point that is greater than or equal to about 1,500° C.

It is generally desirable for the coarse particles to comprise oxides, carbides, nitrides, oxycarbides, or oxynitrides of a transition metal, a poor metal or a metalloid. Transition metals are those contained in Groups 3 to 12 of the periodic table as defined by the International Union of Pure and Applied Chemistry (IUPAC). Poor metals are those contained in Groups 13 to 16 of the periodic table as defined by the International Union of Pure and Applied Chemistry (IUPAC). Alloys of these metal carbides, metal nitrides, metal oxycarbides, or metal oxynitrides can also be used.

Examples of suitable metals (that can be used in oxide, carbide, nitride, oxycarbide or oxynitride form) are aluminum, titanium, zirconium, titanium, tantalum, molybdenum, chromium, or the like, or a combination comprising at least one of the foregoing metals. An example of suitable metalloid is silicon.

Suitable examples of the materials from which the coarse particles can be obtained are silicon dioxide, silicon carbide, silicon nitride, silicon oxynitrides, silicon oxycarbides, aluminum oxide, aluminum carbide, aluminum nitride, aluminum oxynitrides, aluminum oxycarbides, titanium boride, titanium carbide, titanium dioxide, titanium nitride, titanium oxynitrides, titanium oxycarbides, tantalum oxide, tantalum boride, tantalum carbide, tantalum nitride, tantalum oxynitrides, tantalum oxycarbides, zirconium dioxide, zirconium boride, zirconium carbide, zirconium nitride, zirconium oxynitrides, zirconium oxycarbides, molybdenum oxide, molybdenum boride, molybdenum carbide, molybdenum nitride, molybdenum oxynitrides, molybdenum oxycarbides, molybdenum silicide, or the like or a combination comprising at least one of the foregoing materials. In one exemplary embodiment, it is desirable to use silicon carbide particles in the slurry to facilitate the creation of the rough surface on the substrate.

The coarse particles can have a particle size from about 0.1 to about 1000 micrometers, specifically about 1 to about 500 micrometers, and more specifically about 5 to about 300 micrometers.

The slurry can comprise the coarse particles in an amount of about 1 to about 70 weight percent (wt %), based upon the total weight of the slurry. A preferred amount of the coarse particles is about 15 to about 25 wt %, based upon the total weight of the slurry.

In one embodiment, the adhesion of the EBC to the coarse particles is a function of the mechanical properties of the particles and the number of particles per unit area. Therefore, at the EBC/substrate interface, the fractional cross-sectional area occupied by the coarse particles multiplied by the coarse particle strength should exceed the desired interfacial debond strength between the EBC and the substrate.

The slurry 106 can be mixed using shear force, extensional force, compressive force, ultrasonic energy, electromagnetic energy, thermal energy or combinations comprising at least one of the foregoing forces or forms of energy, and can be conducted in processing equipment wherein the aforementioned forces or forms of energy are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing types of processing equipment.

Mixing involving the aforementioned forces may be conducted in machines such as single or multiple screw extruders, Buss kneader, Henschel, helicones, Ross mixer, Banbury, roll mill, ball mill, a paint shaker, or the like, or combinations comprising at least one of the foregoing machines.

In one method, in one manner of manufacturing an article comprising the rough surface, a substrate can be impregnated with the slurry (without the coarse particles) by tape casting, roll coating, spray coating, thermal spray coating, or the like, or a combination comprising at least one of the foregoing impregnation methods to form an impregnated substrate.

The substrate with layer of coarse particles disposed thereon as shown in the FIGS. 1 through 4 may then be subjected to a second lamination and heat treatment. The second lamination process can include covering the coated substrate with a release film, breather cloth and a vacuum bag and then treating the covered coated substrate in an autoclave.

In an embodiment, the release film, breather cloth and a vacuum bag are optionally removed prior to heat treatment. Alternatively, the use of the release film and breather cloth can be omitted during the second lamination process. The lamination is generally conducted for about 10 to about 25 hours in an autoclave at a first heat treatment temperature of about 100 to about 150° C. and a pressure of about 550 to about 700 kilo Pascals (kPa). In an exemplary embodiment, the lamination is conducted for 18 hours at 125° C. an under a pressure of 620.5 kPa.

The second heat treatment comprises heating the substrate with the coarse particles disposed thereon to a temperature greater than or equal to about 550° C. The second heat treatment is conducted in a vacuum or in an inert atmosphere to promote char yield and avoid oxidizing the substrate. In one embodiment, the substrate with the coarse particle disposed thereon is heated to a temperature of about 600 to about 800° C. In another embodiment, the second heat treatment comprises heating the substrate with the coarse particles disposed thereon to a temperature of about 650 to about 750° C. The time period of the heat treatment is about 10 to about 120 minutes. In the embodiment being described, the heat treatment serves two functions.

The first is a controlled burn out of the organic materials in the slurry 106. The outgassing due to the decomposition of these materials can damage the substrate if done too quickly. Additionally, at least one of the organics is a char yielding material as described in U.S. Pat. No. 6,258,737. It is desirable to have sufficient char to provide the substrate with adequate strength after burnout. The burnout must be conducted in an inert atmosphere, such as nitrogen or vacuum in order to preserve the carbon char as well as any carbon particulates used in the slurry.

A third heat treatment is performed to infiltrate the preform with molten silicon. The silicon converts carbon in the preform into silicon carbide and fills any remaining voids. This heat treatment is conducted under vacuum at pressures of about 2 Torr to about 1 mTorr. The third heat treatment (i.e., the infiltration) is conducted at a temperature above the melting point of the infiltrant alloy which generally comprises more than 90 wt % silicon. The infiltration temperature can be as high as 1800° C. In an exemplary embodiment, the infiltration is conducted at a temperature of about 1400 to about 1450° C. The amount of time required for infiltration is on the order of 10 to 120 minutes. Excess infiltrated silicon can be removed by grit blasting. The burnout and infiltration steps can be combined into one cycle, or can be done separately.

The period of time required for infiltration is determinable empirically and depends largely on the size of the preform and extent of infiltration required. The resulting infiltrated body is cooled in an atmosphere and at a rate that has no significant deleterious effect on it.

Following the burnout and melt infiltration steps, the substrates having the rough surface can be coated with a barrier coating. Suitable barrier coatings are environmental barrier coatings and thermal barrier coatings. The barrier coating is disposed on a surface of the layer comprising the coarse particles that is opposed to the surface that is in contact with the substrate. Suitable examples of environmental barrier coatings are disclosed in the following patents and patent applications, the entire contents of which are hereby incorporated by reference. These are U.S. Pat. No. 6,299,988 to Wang et al., U.S. Pat. No. 6,630,200 to Wang et al., U.S. Patent Application No. 2006/0280953A1 to Hazel et al., U.S. Pat. No. 5,985,470 to Spitsberg et al., U.S. Pat. No. 6,284,325 and U.S. Pat. No. 6,296,942 to Eaton et al, U.S. Pat. No. 5,985,470 to Spitsberg, U.S. Pat. No. 6,312,763 to Wang et al., and U.S. Patent Application No. 2006/0014029A1 to Saak et al.

The disclosed process is further illustrated by the following non-limiting examples, which use the following materials:

### EXAMPLES

This example was conducted to demonstrate the superior properties of the roughened surface produced by the methods disclosed herein versus those produced by grit blasting. A slurry having the composition disclosed in the Table 1 was manufactured as described below.

TABLE 1

| Material | Source |
|---|---|
| SiC powder, HSC 059S | Superior Graphite |
| Carbon powder, Thermax Powder | Cancarb |
| UltraPure | |
| Butvar B79 (polyvinyl butyral resin) | Solutia |
| Furcarb LP340-E | United-Erie, a division of Interstate |
| | Chemical Co. |
| 931 Thinner Binder | Cotronics Corp. |
| Zephrym PD 7000 | Uniqema |
| toluene | |
| 4-methyl-2-pentanone (MIBK) | |

The slurry was prepared by mixing 7.66 parts MIBK, 11.78 parts toluene, 2.06 parts Furcarb, 2.06 parts 931 Thinner Binder, 0.44 parts Zephrym PD 7000, 4.39 parts Cancarb, 10.31 parts SiC and 2.36 parts Butvar B79 in a Nalgene bottle containing 58.91 parts of ZrO2 milling media. The laminated substrate was obtained from General Electric Global Research and was made as described in U.S. Pat. No. 6,258,737.

### Example 1 and Comparative Example 1

The slurry of Table 1 was tape cast on to a carbon veil to form a 0.01 inches thick matrix ply. The matrix ply was cut in to 2 inches×6 inches coupons and 10 coupons stacked to form the substrate approximately 0.1 inches thick. The substrate was cut into two coupons (laminated preforms), numbered 1 and 2 respectively, each having a square surface area of 2 inches×2 inches (on a single surface). Coupon 1 was used for Comparative Example 1 and Coupon 2 used for Example 1.

The surface of Coupon 2 was further processed as follows. The slurry of Table 1 was tape cast on to a matrix only ply to form a 0.005 inches thick matrix ply in a manner similar to that in the FIG. 1. While the matrix only ply was still tacky, the surface was coated with 220 grit silicon carbide then the silicon carbide was pressed in to the surface of the ply with a hand roller, and the excess silicon carbide was removed to form a coarse particle ply approximately 0.015 inches thick. The coarse particle ply was then applied to the opposing faces of Coupon 2 by hand. The source for various items used in the manufacture of the coupons is shown in the Table 3.

TABLE 3

| Material | Source |
|---|---|
| 0.005 inch FEP film | |
| FibreGlast #579 polyester | Fibre Glast Developments Corp. |
| breather/bleeder | |
| FibreGlast #582 Nylon release/peel ply | Fibre Glast Developments Corp. |
| Airweave GS 213 sealant tape | Airtech International |
| Wrighton 7400 bagging film | Airtech International |

Coupons 1 and 2 were first disposed on an aluminum plate with a Teflon sheet between the plate and the coupons and each coupon disposed thereon was covered by a release cloth, breather cloth and vacuum bag film and laminated for 18 hours in an autoclave at 125° C. with 620.5 kilo Pascals (kPa) overpressure.

Following the lamination, the vacuum bag, breather cloth and release film were removed and coupons 1 and 2 were heat treated in a burn out cycle. The burn out cycle was conducted in a vacuum furnace; the furnace being heated with carbon heating elements and insulated from the ambient by carbon insulation. The furnace was evacuated to between 20 mTorr and 1 Torr. The temperature in the furnace was ramped to 700° C. at a rate of 20° C. per hour. The slow heating rate minimizes the rate of outgassing from the decomposition of the organic resins in the matrix precursor and the slurry. Rapid out gassing can damage the substrate. After a 30 minute hold at 700° C., the furnace was allowed to cool back to room temperature.

After removal from the furnace, the samples were stood on edge on a carbon cloth wick. An additional carbon cloth wick contacted the top edge of each sample. Sufficient silicon alloy was placed on each wick in order to completely saturate the wicks and fill the preform while the silicon alloy was molten. The samples and wicks were supported on boron nitride coated graphite hardware. The molten infiltrant moves along the carbon cloth wicks and into the preform by capillary action. The infiltration temperature can be as high as 1800° C., but the preferred range is 1400 to 1450° C. The amount of time required for infiltration is on the order of 10 to 120 minutes. For this example, the temperature in the furnace was ramped over a period of 7.5 hours to 1435° C., where it was held for 60 minutes. The furnace was then allowed to cool to room temperature. After infiltration and cooling to room temperature, the samples were detached from the wicks and the excess silicon was removed by grit blasting with alumina grit at 70 psi.

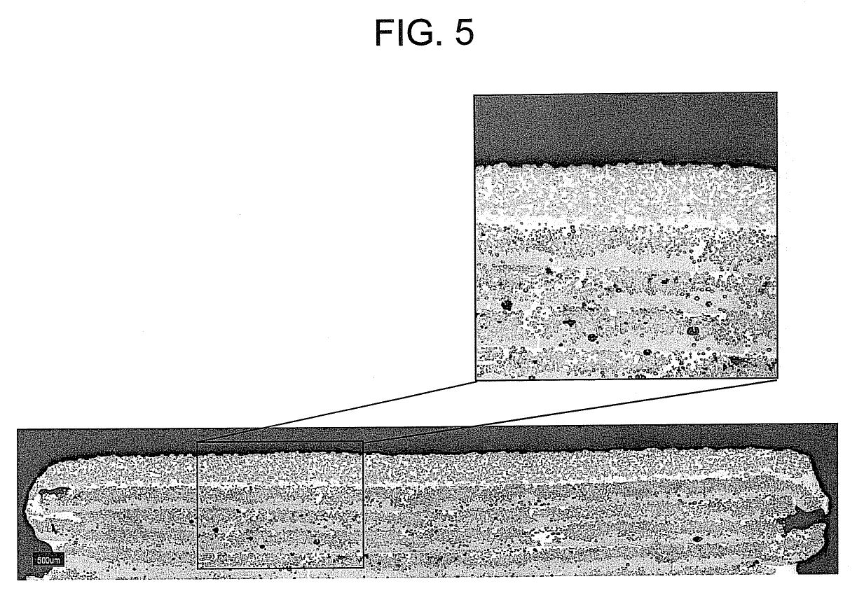

Coupon 1 was further subjected to grit blasting in a commercial grit blast process using 36 grit silicon carbide at 20 to 30 pounds per square inch of pressure. Coupon 2 was not subjected to grit blasting. Coupon 2 was further characterized using microscopy. FIG. 5 is a cross-section micrograph of Coupon 2. The surface roughness due to the coarse particles of silicon carbide can be observed in this image.

Following the manufacturing of Coupons 1 and 2 as described above, both Coupons 1 and 2 were coated with 0.004 inch of silicon using atmospheric plasma-spraying. The pull adhesion strength of the deposited silicon layer on each coupon was then measured using a standard pull-adhesion test method by attaching three steel pull stubs to each coated coupon using an organic adhesive having a tensile strength in excess of 10 ksi.

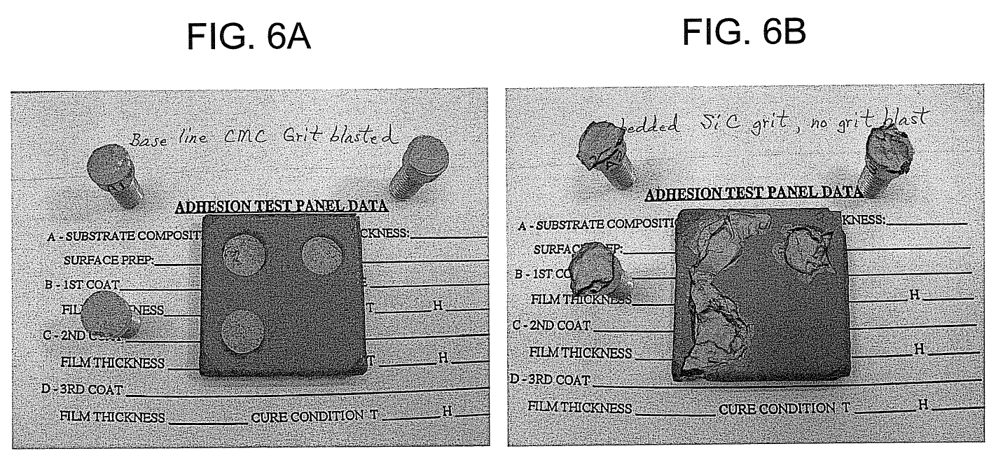

FIG. 6 is a collage of photographs of Coupons 1 (Comparative Example 1-FIG. 6A) and 2 (Example 1-FIG. 6B) depicting the respective failure modes after the pull testing. Coupon 1 failed either at the silicon adhesive or in a cohesive mode between the silicon adhesive and the panel. Coupon 2, on the other hand, failed only in the panel, thus exhibiting superior adhesion. The average strength of Coupon 1 was 1803 pounds per square inch (psi), while the average strength of Coupon 2 was 2978 psi. Thus the roughening of the surface of Coupon 2 using the coarse particle layer produced better adhesion than that produced by the roughening of the surface of Coupon 1 using the standard grit blast procedure. Coupon 2 displays an average adhesive strength that is at least 50% greater than the average adhesive strength displayed by Coupon 1.

### Example 2 and Comparative Example 2

This example was conducted to demonstrate the superior properties of the roughened surface produced by the methods disclosed herein versus those produced by grit blasting. A slurry having the composition used in the Example 1 was used, except for the fact that the coarse particles used was 220 grit silicon carbide powder from Norton Industries. The slurry was prepared in the same manner as disclosed in the Example 1. The coarse slurry was disposed upon a substrate that comprised a monolithic piece of silicon carbide. This matrix ply was then laminated to the sintered silicon carbide substrate to create a substrate having a layer that comprises coarse particles. The substrate with the matrix ply disposed thereon was heat treated during which it was subjected to the burn out and melt infiltration steps described in the Example 1.

Two samples (Coupon #'s 3 and 4) were prepared using the surface layer containing the coarse silicon carbide particles. Two additional coupons (Coupon #'s 5 and 6) were fabricated for comparison. The Coupon #5 was fabricated using the same slurry composition (i.e., the matrix precursor) but without the addition of coarse silicon carbide particles. The Coupon #6 was fabricated from the same monolithic silicon carbide substrate without any additional surface layer. Test Coupons #3, #4 and #5 were submitted through the burn-out and melt-infiltration steps, as described in Example 1, to fabricate the surface layer.

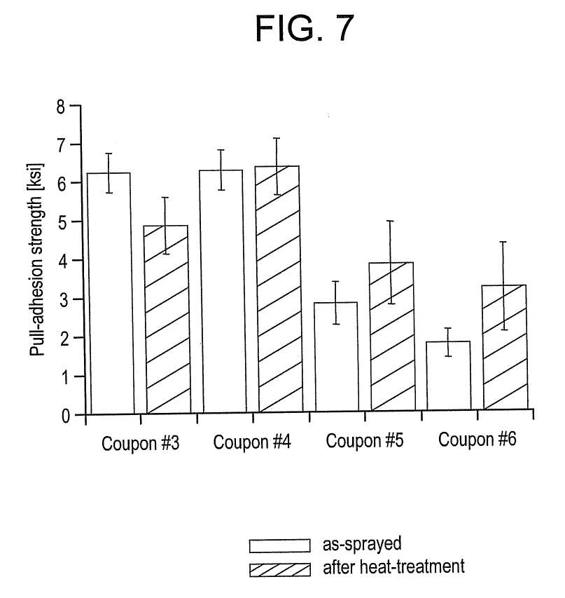

Following the manufacturing of Coupons #3 through #6, Coupons #5 and #6 were roughened by grit blasting using 36 grit silicon carbide particles in preparation for the deposition of a 0.004-inch thick silicon layer using atmospheric plasma spraying. All coupons were then submitted to the silicon deposition process and tested for pull adhesion strength of the coating to demonstrate the Examples of this disclosure. For each of the samples, pull adhesion tests were conducted on the “as coated samples” as well as on the samples after being subjected to a high temperature heat treatment at about 1300° C. As shown by the results summarized in FIG. 7, the adhesion strength of the silicon layer on the coupons containing the surface layer with coarse silicon carbide particles was superior to those of the substrates roughened by the grit blasting process.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. An article comprising:
a substrate; the substrate comprising a ceramic or a ceramic matrix composite; and
a layer comprising coarse particles disposed upon the substrate; the coarse particles having an average particle size of 0.1 to about 1000 micrometers.

2. The article of claim 1, wherein the coarse particle have a melting point that is greater than or equal to about 1500° C.

3. The article of claim 1, wherein the ceramic or ceramic matrix composite comprises silicon.

4. The article of claim 1, wherein the ceramic or ceramic matrix composite comprises silicon carbide fibers.

5. The article of claim 1, wherein the substrate comprises a laminate.

6. The article of claim 5, wherein the laminate comprises a ply; the ply comprising a
reinforcing fiber.

7. The article of claim 1, wherein the reinforcing fiber is a carbon fiber, a silicon carbide fiber, or a combination comprising at least a carbon fiber or a silicon carbide fiber.

8. The article of claim 1, wherein the layer comprising coarse particles is in intimate contact with the substrate.

9. The article of claim 1, wherein the coarse particles comprise oxides, carbides, nitrides, oxycarbides, or oxynitrides of a transition metal, a poor metal or a metalloid.

10. The article of claim 1, wherein the coarse particles comprise metal carbides, metal nitrides, metal oxycarbides, metal oxynitrides, or a combination comprising at least one of the foregoing particles.

11. The article of claim 1, wherein the coarse particles comprise silicon dioxide, silicon carbide, silicon nitride, silicon oxynitrides, silicon oxycarbides, aluminum oxide, aluminum carbide, aluminum nitride, aluminum oxynitrides, aluminum oxycarbides, titanium boride, titanium carbide, titanium dioxide, titanium nitride, titanium oxynitrides, titanium oxycarbides, tantalum oxide, tantalum boride, tantalum carbide, tantalum nitride, tantalum oxynitrides, tantalum oxycarbides, zirconium dioxide, zirconium boride, zirconium carbide, zirconium nitride, zirconium oxynitrides, zirconium oxycarbides, molybdenum oxide, molybdenum boride, molybdenum carbide, molybdenum nitride, molybdenum oxynitrides, molybdenum oxycarbides, molybdenum silicide, or the like or a combination comprising at least one of the foregoing coarse particles.

12. The article of claim 1, wherein the coarse particles comprise silicon carbide.

13. The article of claim 1, further comprising a barrier coating; the barrier coating being disposed on a surface of the layer comprising coarse particles, the surface being opposed to a surface of the layer comprising coarse particles that contacts the substrate.

14. The article of claim 13, wherein the barrier coating is an environmental barrier coating or a thermal barrier coating.

15. An article that employs the article of claim 1.

16. A method comprising:
disposing coarse particles on a substrate; the substrate comprising a ceramic or a ceramic matrix composite; the coarse particles having an average particle size of 0.1 to about 1000 micrometers.

17. The method of claim 16, wherein the disposing the coarse particles on the substrate is accomplished by sprinkling the coarse particles onto the substrate.

18. The method of claim 16, wherein the disposing the coarse particles on the substrate is accomplished by coating the substrate with a slurry that comprises the coarse particles.

19. The method of claim 18, wherein the slurry is manufactured in a paint shaker.

20. The method of claim 16, wherein the disposing the coarse particles on the substrate is accomplished by dip coating, spray painting, thermal spray coating, electrostatic spray painting, brush painting, or a combination comprising at least one of the foregoing methods.

21. The method of claim 17, further comprising disposing a layer of solvent or a matrix precursor slip onto the substrate.

22. The method of claim 16, wherein the disposing the coarse particles on the substrate is accomplished by first disposing the coarse particles on a ply to form a coarse particle ply followed by laminating the coarse particle ply onto the substrate.

23. The method of claim 16, further comprising heat treating the substrate having the coarse particles disposed thereon.

24. The method of claim 23, wherein the heat treating is conducted at a temperature of about 550 to about 800° C.

25. The method of claim 24, further comprising melt infiltrating the substrate having the coarse particles disposed thereon with silicon.

26. The method of claim 25, wherein the melt infiltrating is conducted after a heat treatment of the substrate having the coarse particles disposed thereon.

27. The method of claim 16, further comprising disposing a barrier coating on a surface of the coarse particles.

28. An article manufactured by the method of claim 16.
